(19) United States
(12) Patent Application Publication
(10) Pub. No.: US 2015/0306698 A1
(43) Pub. Date: Oct. 29, 2015

(54) Thermal Management for a Super Capacitor Power Supply

(71) Applicant: Aaron A. Astle, Payson, UT (US)

(72) Inventor: Aaron A. Astle, Payson, UT (US)

(21) Appl. No.: 14/262,743

(22) Filed: Apr. 26, 2014

(51) Int. Cl. B23K 11/26; G05F 3/16

(52) U.S. Cl. CPC B23K 11/26; G05F 3/16

(57) ABSTRACT

A power supply assembly, suitable for use in conjunction with a capacitive discharge welder, comprises an integrated thermal management system. The housing of the power supply assembly allows the integration of ultra-capacitor thermal management with electrical connectivity and mechanical modularity. In the most preferred embodiments of the present invention, aluminum (or other conductive material, such as copper, etc.) channels are shaped and arranged to both act as thermal fin elements for the removal of waste heat while simultaneously serving as an electrical path with a relatively low electrical resistance. The thermal fin assembly may comprise self-isolating insulation elements or the thermal fin elements may be electrically isolated from each other by an electrically insulating material. Airflow within the housing may be directed via fan or other method into the ultra-capacitor wind tunnel to remove heat from the capacitor cylinder itself as well as the thermal conductive fin elements.

### CROSS REFERENCE TO RELATED APPLICATIONS

This application is a continuation-in-part of U.S. patent application Ser. No. 14/084,575, which application was filed on Nov. 19, 2013, and which application is currently pending and which application is incorporated herein by reference.

### BACKGROUND OF THE INVENTION

1. Technical Field

This invention relates to the field of welding and more particularly relates to thermal management systems for welding equipment.

2. Background Art

Capacitive discharge welders (CD welders), also called capacitive resistance or capacitor discharge spot welders, have been in use in a variety of industries for many years. These welding systems are used to produce quick burst of energy for controlled energy transfer into a specific weld spot. CD welders utilize capacitors, with an electrical circuit charging the energy in the capacitors to the desired level. The total capacitor energy is typically released in a very short time to the weld location through a welding transformer, producing the current required to make the weld.

CD welders have many advantages over other types of welder. For example, CD welders deliver a quick energy release for welding highly conductive metals such as copper. Another advantage of CD welders compared with typical AC welding machines is that CD welders have a higher power factor and balanced line loading when powered by a three-phase power supply and do not typically exhibit the “cycling” behavior that is common in AC machines. DC welders are relatively energy efficient and the weld energy is applied directly to the work piece without any significant heat loss.

Similarly, CD welders are capable of concentrating the weld energy into relatively small weld zones while offering a repeatable energy release that is largely independent of supply line voltage fluctuations. Finally, CD welders are generally capable of very fine energy adjustments to allow greater control of the weld energy for precision welding applications. However, CD welders are not without certain drawbacks and limitations that are directly related to the use of capacitors as a power source.

For example, the lifetime of ultra-capacitors decays exponentially with operational temperature. Ultra-capacitors can experience high weld currents and can have a significant temperature rise during the welding processes. In order to achieve ultra-capacitor welding power supply lifetimes of approximately 10 years, the capacitors must be maintained at close to room temperature with a nominal temperature rise of single digit degrees Celsius instead of the typical rise of more than 10-20 degrees that is typical for most common applications. Using ultra-capacitors will continue to be sub-optimal.

### SUMMARY OF THE INVENTION

Disclosed herein is a power supply assembly for a capacitive discharge welder that comprises an integrated thermal management system. The housing of the power supply assembly allows the integration of ultra-capacitor thermal management with electrical connectivity and mechanical modularity. In the most preferred embodiments of the present invention, aluminum (or other conductive material, such as copper, etc.) channels are shaped and arranged to both act as thermal fin elements for the removal of waste heat and as an electrical path (parallel, series or a combination of series and parallel) with a relatively low electrical resistance. The fin elements are attached to the capacitor terminals of the power supply housing using nuts and bolts, welds or some other acceptable method known to those skilled in the art.

The thermal fin assembly can be designed to comprise naturally self-isolating elements. Additionally, the thermal fin components may also be electrically isolated from each other by the use of an electrically insulating material (e.g. plastic) to create an insulative outer layer or shell around the thermal fin assembly. The insulative outer shell also helps to form a wind tunnel and allows a single ultra-capacitor power supply module to be stacked and/or mounted in series or parallel with plurality of similar ultra-capacitor power supply modules to create a larger power supply. Airflow within the housing may be directed via fan or other method into the ultra-capacitor wind tunnel to remove heat from the capacitor cylinder itself as well as the thermal conductive fin elements. Two fin elements allow attachment of an external electrical path for the charging and discharging of the capacitor array.

### BRIEF DESCRIPTION OF THE FIGURES

The preferred embodiments of the present invention will hereinafter be described in conjunction with the appended drawings, wherein like designations denote like elements, and:

FIG. 1 is a diagram depicting the energy density and power density relationship for various types of power sources;

FIG. 2 is a schematic diagram of an ultra-capacitor welder suitable for use in conjunction with an ultra-capacitor welder with an integrated thermal management system accordance with a preferred embodiment of the present invention;

FIG. 3 is a perspective partial cutaway view of an ultra-capacitor power supply with fins suitable for use in conjunction with an ultra-capacitor welder with an integrated thermal management system in accordance with a preferred embodiment of the present invention;

FIG. 4 is a perspective partial cutaway view of an ultra-capacitor power supply with fins and isolation elements suitable for use in conjunction with an ultra-capacitor welder with an integrated thermal management system in accordance with a preferred embodiment of the present invention;

FIG. 5 is a side cutaway view of an ultra-capacitor with fins suitable for use in conjunction with an ultra-capacitor welder with an integrated thermal management system in accordance with a preferred embodiment of the present invention;

FIG. 6 is a side cutaway view of an ultra-capacitor with fins and isolation elements suitable for use in conjunction with an ultra-capacitor welder with an integrated thermal management system in accordance with a preferred embodiment of the present invention;

FIG. 7 is a side cutaway view of an ultra-capacitor with fins and isolation elements suitable for use in conjunction with an ultra-capacitor welder with an integrated thermal management system in accordance with an alternative preferred embodiment of the present invention;

FIG. 8 is a side cutaway perspective view of an ultra-capacitor power supply with fans suitable for use in conjunction with an ultra-capacitor welder with an integrated thermal management system in accordance with a preferred embodiment of the present invention;

FIG. 9 is a side cutaway perspective view of an ultra-capacitor power supply with fans suitable for use in conjunction with an ultra-capacitor welder with an integrated thermal management system in accordance with an alternative preferred embodiment of the present invention;

FIG. 10 is a perspective view of various configurations for an array of ultra-capacitors suitable for use in an ultra-capacitor welder with an integrated thermal management system in accordance with a preferred embodiment of the present invention;

FIG. 11 is a circuit schematic of a plurality of ultra-capacitors connected in series to be used in conjunction with a ultra-capacitor power supply with an integrated thermal management system in accordance with a preferred embodiment of the present invention;

FIG. 12 is a circuit schematic of a plurality of ultra-capacitors connected in parallel to be used in conjunction with a ultra-capacitor power supply with an integrated thermal management system in accordance with a preferred embodiment of the present invention;

FIG. 13 is a circuit schematic of a plurality of ultra-capacitors connected both in series and in parallel to be used in conjunction with a ultra-capacitor power supply with an integrated thermal management system in accordance with a preferred embodiment of the present invention;

FIG. 14 is a partial cutaway perspective view of one configuration for an ultra-capacitor power supply suitable for use in conjunction with an ultra-capacitor welder with an integrated thermal management system in accordance with a preferred embodiment of the present invention;

FIG. 15 is a partial cutaway perspective view of one configuration for an ultra-capacitor power supply suitable for use in conjunction with an ultra-capacitor welder with an integrated thermal management system in accordance with a preferred embodiment of the present invention;

FIG. 16 is a partial cutaway perspective view of one configuration for an ultra-capacitor power supply suitable for use in conjunction with an ultra-capacitor welder with an integrated thermal management system in accordance with a preferred embodiment of the present invention;

FIG. 17 is a partial cutaway perspective view of a configuration for an ultra-capacitor power supply suitable for use in conjunction with an ultra-capacitor welder with an integrated thermal management system in accordance with a preferred embodiment of the present invention; and

FIG. 18 is a partial cutaway perspective view of a configuration for an ultra-capacitor power supply suitable for use in conjunction with an ultra-capacitor welder with an integrated thermal management system in accordance with a preferred embodiment of the present invention.

### DETAILED DESCRIPTION OF THE PREFERRED EMBODIMENTS

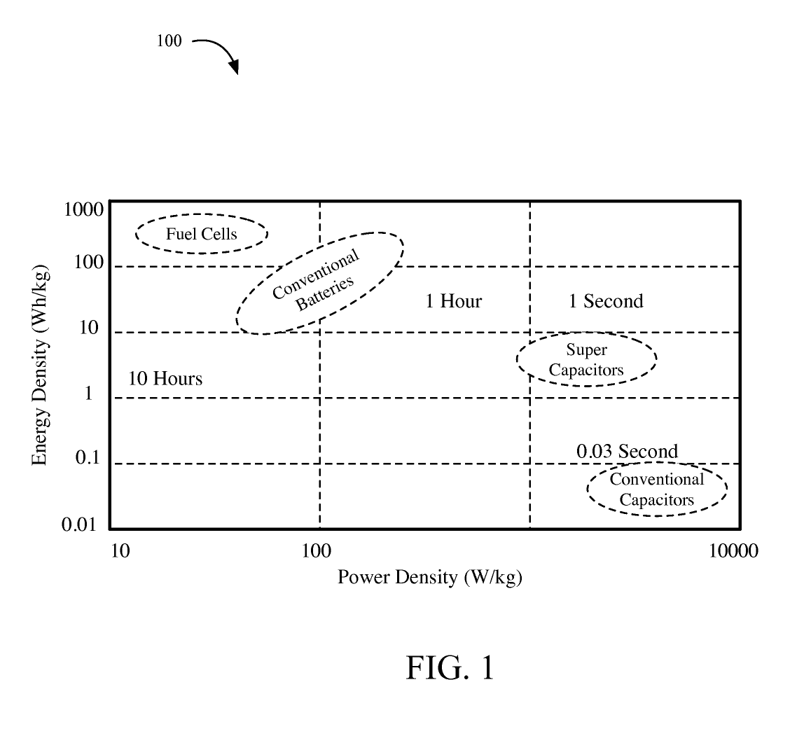

A “super capacitor,” also known as an electric double-layer capacitor or “ultra-capacitor,” can be defined as an electrical component characterized by both double-layer capacitance and pseudocapacitance. Presently known super capacitors may have up to 10,000 times the capacitance of a conventional electrolytic capacitor and anywhere from 10 to 100 times the power density of a conventional battery. The relative ratio of power density and energy density for various power sources is illustrated in FIG. 1. As shown in FIG. 1, super capacitors are capable of delivering significantly higher performance for applications where higher levels of energy and power density are desirable.

The high energy density combined with high power density of super capacitors allows very large amounts of energy to be stored in a super capacitor with rapid charge and discharge cycles. A welder with a capacitive power source (e.g., a typical CD welder or Linear DC welder) that would typically be capable of storing 1,000 joules of energy using conventional capacitors could theoretically store in excess of 100,000 joules of energy if the super capacitor technology were successfully deployed. This dramatic increase in energy storage capacity has the possibility of dramatically improving the performance of the welder.

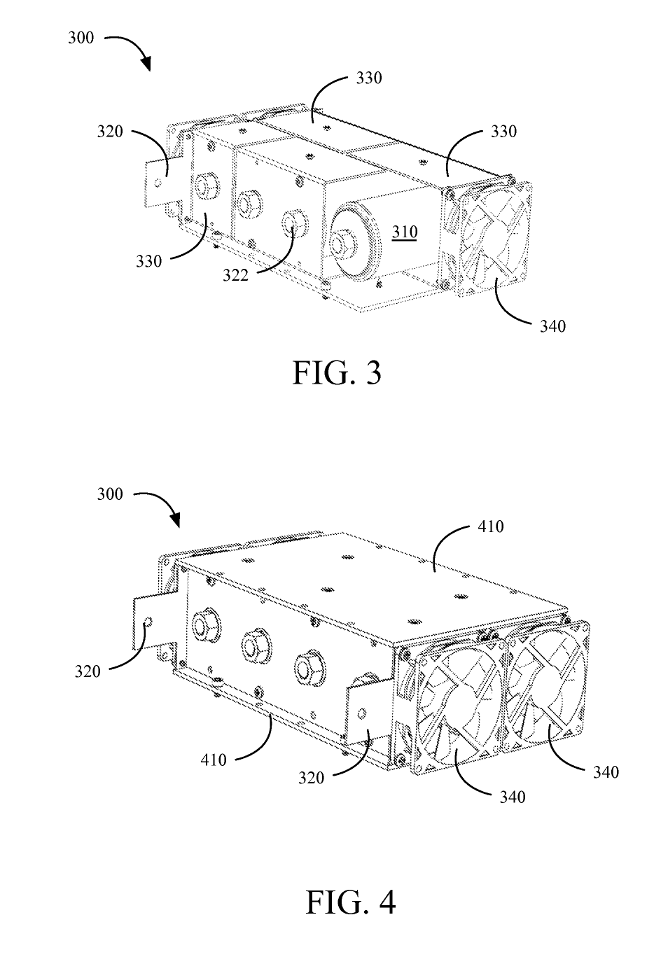

Ultra-capacitors or any double ended cylindrical capacitor, battery, or power source (e.g. graphine capacitor, power supply, etc.) is arranged in a series or parallel arrangement or a combination of the two as shown in FIG. 3 and FIG. 4 below. This class of double-ended item will be referred to as “cylindrical power source” in the text.

In the most preferred embodiments of the present invention, the cylindrical power source is bolted, welded or otherwise attached to the electrically and thermally conductive heat sink. The heat sink components are configured is such a way to create the electrical series parallel (or combination of the two) conduction path. The heat sink components are geometrically designed to allow fluid flow across the fin surface as well as flow across the cylindrical power source. The fin components also mechanically hold the cylindrical power source in their series, parallel or combination of the two configurations.

In at least some preferred embodiments of the present invention, the assembled cylinder power sources and fins may also be electrically isolated using an isolating sheeting or insulating material such as a plastic coating, etc. The isolation element may also be advantageously positioned in concert with the fins to direct airflow efficiently around the fin and cylinder assembly. The isolation elements can further be designed to bond directly to the outer portion of the wind tunnel formed by the fins, thereby exposing only the inner surface of the fins to fluid flow. Alternatively, the isolation elements can be spaced apart from the outer fin surface to allow fluid flow on both the outer and inner fin surfaces to increase heat removal efficiency.

Although attaching one or more isolation elements to the fin assembly is not strictly necessary for the functionality of the present invention, it is generally considered desirable for a number of reasons. For example, the isolation elements may improve assembly mechanical strength and can improve heat transfer efficiency by directing fluid flow to important surfaces. The isolation element can also be configured to allow efficient modularity to the structure of the ultra-capacitor power supply, allowing multiple modules to be stacked without introducing any electrical conduction or connection between the modules in unwanted locations etc.

In at least some preferred embodiments of the present invention, the entrance or exit opening of the tunnel formed by the fins for the ultra-capacitor power supply may be fitted with a fluid flow device or method to enhance airflow and heat dissipation. The device may be mechanical in nature, such as a fan, or may be an arrangement of components configured to take advantage of natural physical phenomena such as free convection in a working fluid. This may be accomplished with advantageous geometry such as placing the fin assembly in a vertical orientation to allow the working fluid to be drawing in at the bottom and exit the top or the power supply assembly. The working fluid need not be limited to air and, in at least some preferred embodiments of the present invention, may comprise a fluid such as oil or water. A forced convection device such as a fan is deployed in the most preferred embodiments of the present invention to achieve higher forced convection heat transfer values along the fin surface and cylinder power source.

The basic elements of the modular cylindrical ultra-capacitor thermal management system with integrated electrical connectivity in accordance with the most preferred embodiments of the present invention include: at least one cylindrical ultra-capacitor or double ended capacitor or power supply (e.g., graphine capacitor, etc.) at least two integrated thermal fin and electrical conduction elements; a cooling device for forced air convection (e.g., a fan or multiple fans on inlet and/or outlet) or a free convection conducive geometric orientation of the components; and an optional isolation element such as plastic isolation element.

It is important to note that the various preferred embodiments of the present invention described herein can be scaled to include multiple ultra-capacitors arranged in various configurations. Various preferred embodiments of the present invention may include series or parallel arrangement or both (e.g., integrated series and parallel arrangements) or arrays of ultra-capacitors or other cylindrical double-ended heat producing devices (e.g. high power resistors, graphine capacitors, conventional capacitors with polls on opposite ends of the cylinder). Those skilled in the art will recognize that all of these variations are encompassed in the descriptions set forth herein.

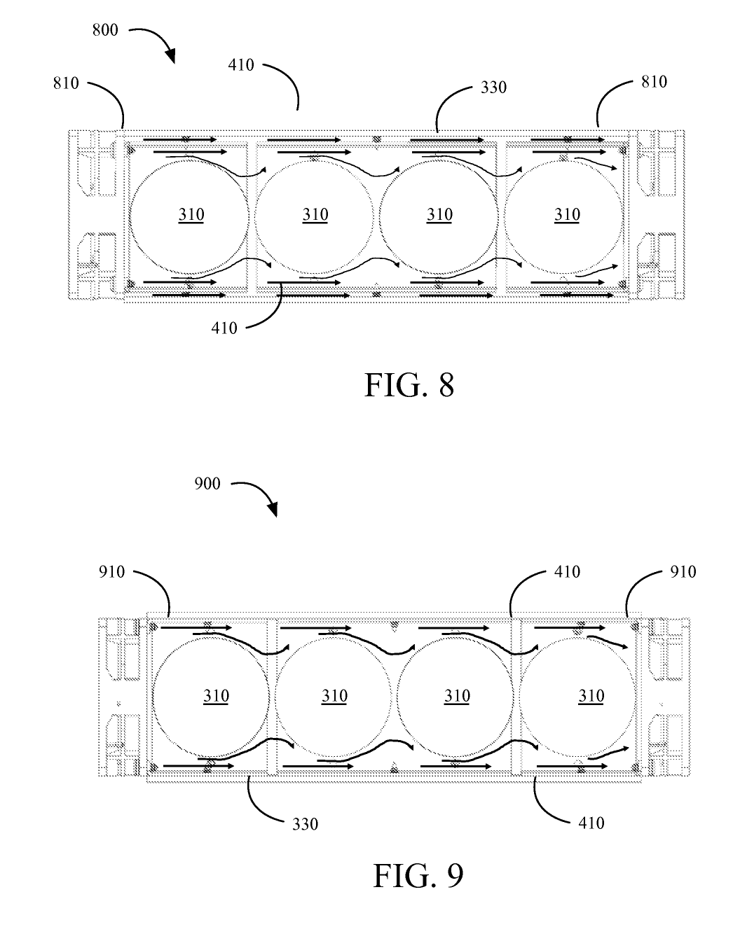

Regardless of the physical arrangement and orientation, the ultra-capacitors or arrays of ultra-capacitors are thermally and electrically connected with a series of 2 or more finned elements. The finned elements are designed to mechanically and electrically join the ultra-capacitors in the proper orientation relative to one another to produce the series, parallel or series and parallel desired coupled arrays. The heat sink fin components are arranged to allow cross flow of a cooling medium on both the cylinder body of the ultra-capacitors and the fin elements. The flow can be directed only to one side or flat surface of the fins as shown in FIG. 9 below or arranged to pass over both fin surfaces as shown in FIG. 8 below.

In the most preferred embodiments of the present invention, the fin elements also act as a low resistance electrical path for conducting electrical current to and from the cylinder power source. The fin elements may also comprise one or more mounting holes that allow isolation elements, such as one or more plastic sheets to be attached for additional structural and mechanical re-enforcement as well as electrical isolation of the components contained within the fin elements. The isolation elements enhance structural integrity for the modular unit for stacking, jointing, mounting into a larger system. Each power supply module can be expanded by connecting more cylindrical ultra-capacitors modules in series or in parallel, depending on the specific application.

In at least some preferred embodiments of the present invention, one or more fans can be added to inlet and outlet of the ultra-capacitor power supply assembly to produce forced fluid flow and/or forced convection. This cooling method allows the ultra-capacitor power supply assembly to remain at desired temperature levels so as to extend lifetime operation and improve MTBF rates for the ultra-capacitor power supply assembly.

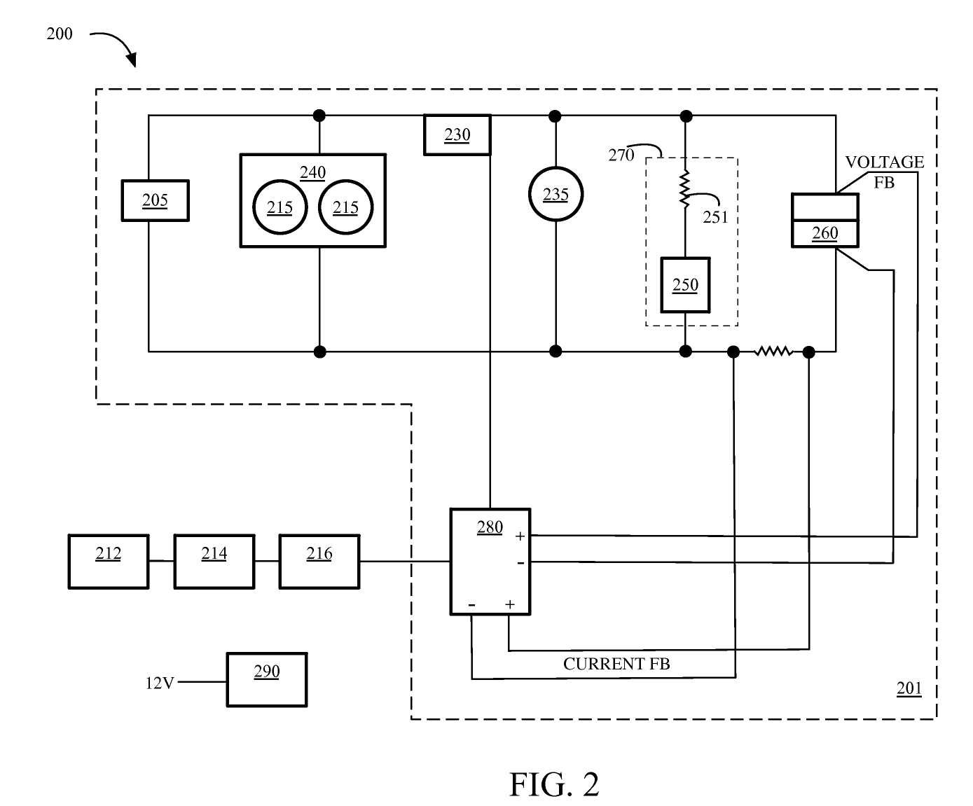

Referring now to FIG. 2, a schematic diagram for a preferred embodiment of an ultra-capacitor welder 200 is depicted. Welder 200 includes several functions and features from previous welding systems while incorporating additional functions and features that are unique to the present invention. For example, welder 200 comprises: a power board 201; a user interface device 212; a central processing unit (CPU) or control circuit 214; a control board 216; an emergency stop control 290.

The most preferred embodiments of power board 201 used in conjunction with ultra-capacitor welder 200 comprises: a power source 205; a super capacitor power supply 240; a weld switch 230; a power supply control circuit 280; a filter capacitor 235; and an emergency stop circuit 270. As shown in FIG. 2, emergency stop circuit 270 comprises an emergency switch 250 and a resistor 251.

User interface device 212 is a device used by an operator to communication with welder 200 and to control the operation of welder 200. While user interface device 212 may be any one of several devices, the most preferred embodiments of the present invention will incorporate a tablet computer such as an iPad® or similar device (e.g., Android® tablet, Windows® Surface® tablet, etc.). There are a number of other easy-to-use touch interfaces devices as well and all of these devices may be used to provide a graphical user interface for enhancing the welding process using welder 200. The most preferred embodiments of the present invention will most preferably comprise a user interface device 212 configured to communicate via a wired or wireless connection with control board 216. While many communication protocols may be used, the most preferred embodiments of the present invention use Universal Serial Bus (“USB”) communications device class (“CDC”) to send bulk data transfers from user interface device 212 to control board 216.

Central processing unit (CPU) or control circuit 214; represents a digital microprocessor or micro controller, microcontroller (“MCU”) or similar device. CPU 214 receives the USB signal from user interface device 212 and communicates with control board 216 to control the welding operation of welder 200. CPU 214 also controls universal asynchronous receive/transmit (“UART”) communication to a programmable logic controller (“PLC”) for data acquisition from feedback at the weld point, and other signals to control the welding parameters and welding operation for welder 212.

Control board 216 is configured to communication with user interface device 212 and power supply control 280. Control board 216 receives the USB signals from user interface device 212 via CPU/control circuit 214. The most preferred embodiments of the present invention may also have one or more temperature monitors on the ultra-capacitors, charge MOSFETs, weld MOSFETs, weld out positive terminal, weld out negative terminal. All of these temperatures will be acquired by the same MCU. This MCU operates at 70 MIPS and provides the speed we need to adjust weld parameters accurately.

Control board 216 also includes a plurality of opto-isolators to reduce or eliminate large voltage or current spikes that may adversely effect the operation of the MCU. All signals that control the charging of the capacitors, welding, bleeding and emergency bleed circuit run through these opto-isolators. Essentially, any signal that controls a component that could potentially put a dangerous voltage on the MCU has been routed through an opto-isolator.

As shown in FIG. 2, a current feedback and voltage feedback circuit is also used to monitor the welding process. Voltage feedback and current feedback are monitored at a designated rate (typically in the range of 10 kHz-25 kHz, or more) during the welding cycle. The current feedback and voltage feedback is supplied to control board 216 and, in turn, to power supply control 280. As the welder receives the voltage and current feedback, it makes adjustments during the weld to stay within the input parameters supplied by the user via user interface device 212.

Power source 205 is any suitable power source that may be deployed to energize super capacitor power supply 240 and is most preferably a standard 110V/220V power supply. The most preferred embodiments of the present invention comprise a constant current limited power supply.

Super capacitor power supply 240 comprises at least one super capacitor 215 that are used as a power source within welder 200 where super capacitors 215 are repeatedly cycled or switched on and off to the weld path via weld switch 230 at a controlled rate with the output being filtered by filter capacitor 235 to optimize weld precision. In the most preferred embodiments of the present invention, the actual number of super capacitors 215 will be determined by the specific requirements of the welding application. Similarly, super capacitors 215 may be configured and electrically connected in a series or parallel fashion, as needed to meet the power and output requirements for the application. It will understood by those skilled in the art that the circuit designs described herein are illustrative in nature and no limitation as to the specific number or arrangement of capacitors 215 is intended hereby.

When using super capacitors 215 as the main power source for a weld, it is necessary to provide a way of switching these capacitors to and from the weld path. Using super capacitors 215, therefore, requires intermediate circuitry with a high enough current and voltage rating to be able to manage the maximum current and voltage generated by super capacitor power supply 240 while maintaining the capability to rapidly switch super capacitor power supply 240 on and off of the weld path at high frequencies if welder 200 was configured as a filtered output DC type system.

While the enhanced capabilities of super capacitor power supply 240 are significant, there are additional considerations that are important to address with this unique design. For example, the significantly higher levels of energy stored in super capacitor power supply 240 significantly increases the possible danger if the welder failed and an unintended discharge of the energy resulted. Specifically, given the high power storage capabilities associated with super capacitor power supply 240, if the weld circuit were to fail in a closed condition, which is the most likely failure scenario, a very large amount of stored energy may be inadvertently discharged from welder 200 in an undesirable fashion.

In order to eliminate or reduce this possibility, the most preferred embodiments of the present invention comprise an emergency stop circuit. The emergency stop circuit is configured to remove the current from the circuit until the ultra-capacitor bank is to a safe voltage. This circuit will also turn off the power supply used to charge the ultra-capacitor bank, and will enhance the operational safety for a super capacitor based welder. Emergency stop circuit 270 is configured to redirect energy internally (e.g., in parallel) or, in an alternative preferred embodiment of the present invention, the emergency stop circuit may be arranged in a series configuration so as to interrupt the welding circuit in a failure mode. Finally, in at least one preferred embodiment of the present invention, the emergency stop circuit may be arranged in a hybrid fashion that is a combination of both series and parallel configurations.

Those skilled in the art recognize that the use of an emergency stop circuit 270 is not needed with conventional capacitive discharge welders since conventional capacitors are incapable of storing enough energy to maintain a long enough weld to cause the degree of damage a super capacitor based welder may cause. With a prior art linear DC welder, simply disconnecting the power supply from the capacitors is all that is needed to provide for most emergency situations. Although a part may be ruined at the weld point, a catastrophic failure will not cause significant damage outside of the typical linear DC welder because any residual energy is quickly dissipated before any significant damage can occur.

However, with the introduction of super capacitors 215 as a power source for welder 200, an emergency stop circuit 270 that is configured to safely mitigate potential inadvertent electrical discharges in a failure scenario is highly desirable for safe operation of welder 200. Emergency stop circuit 270 is most preferably configured to redirect the stored energy from super capacitors 215 internally (parallel) or be placed in series to break the circuit in a failure mode, or a combination of both.

Unlike conventional CD welders, simply disconnecting power supply 205 from super capacitor power supply 240 is not enough. Once power supply 205 is disconnected, there is still up to 75,000 J (Joules) of energy (or more) stored in super capacitors 215 of super capacitor power supply 240. If the catastrophic failure is in the “switch” portion of the circuit shown in FIG. 2, which is the most probable situation for a failure, super capacitors 215 will continue to discharge at the weld point. The discharge of the energy from super capacitors 215 may cause melting of electrodes, significant damage to the weld piece, or even burns to the operator of welder 200 from molten metal coming from the weld point. This makes it desirable to have an emergency stop circuit that can either completely disconnect the weld path, or an emergency stop circuit that can redirect the majority of the weld current to an isolated, safe location.

Given the undesirable consequences associated with the inadvertent discharge of energy from super capacitors 215, emergency stop circuit 270 is included in the most preferred embodiments of the present invention, in at least one of two ways, as described above. One preferred embodiment of the present invention comprises an emergency stop circuit 270 that is configured to redirect the weld current, through one or more emergency switches 250, to a predefined path to a resistor 255, thereby dissipating the stored energy from super capacitors 215 within welder 200.

Switch 250 is most preferably a MOSFET switch and is controlled by emergency stop circuit 270, Switch 250 serves to transfer the bulk of the energy from the weld point to resistor 251, and ensure the availability of an enclosed location where an internal resistance would be rated to quickly dissipate any energy stored within welder 200. In the most preferred embodiments of the present invention, resistor 251 is on the order of 2 milliohms. This relatively small resistance models the probable resistance at a typical weld spot but the actual resistance of resistor 251 may vary and will be adjusted for specific welding applications. The resistance provided by resistor 251 will most preferably be configured to cut the current at the weld point at least in half. In this manner, two paths current dissipation paths are provided, allowing the current generated by super capacitors 215 to be drained much more quickly. Rather than a 20 second discharge from super capacitors 215, the current discharge time can be reduced to 6-10 seconds. This will significantly reduce the possibility of generating molten metal at the weld output and make welder 200 safer to operate and service.

The second form of emergency stop circuit comprises a circuit with a mechanical or solid-state relay with sufficient voltage and current ratings to be able to switch a maximum weld current from super capacitors 215. This would enable super capacitors 215 to maintain their charge, and rather than redirecting the energy from super capacitors 215 into the form of heat within welder 200, the emergency stop circuit would completely isolate super capacitors 215 from any discharge point so as to stop any current transfer that could potentially cause damage in an emergency situation. It should be noted that the implementation of an emergency stop circuit using a disconnection or isolation approach may be implemented within or without a fluid of high dielectric constant.

While the isolation of the weld path is certainly a viable alternative approach for implementing an emergency stop circuit, there are several disadvantages to this approach. First, the inclusion of a mechanical switch or relay in line with the weld path introduces undesirable resistance which tends to limit the maximum current welder 200 can produce. Second, given the relatively high level of current being generated, a mechanical switch may cause arcing within the relay and destroy the relay, possibly introducing another failure point.

Accordingly, the redirection of the current from super capacitors 215 to resistor 251 is generally considered to be more preferable than simply disconnecting super capacitors 215 from the weld path and leaving the energy stored in super capacitors 215 in an emergency situation. The redirection approach to implementing emergency stop circuit 270 is designed to completely drain super capacitors 215 of all stored energy, using resistor 251. Emergency stop circuit 270 would also be able to function as a capacitor discharge circuit when no load is connected to the external weld path. This circuit may also be used to drain filter capacitor 235 if necessary, should filter capacitor 235 be energized between weld cycles so as to prevent damage to components when contact is made with the work piece.

Referring now to FIG. 3, a perspective cutaway view of an ultra-capacitor power supply 300 with fins suitable for use in conjunction with an ultra-capacitor welder with an integrated thermal management system in accordance with a preferred embodiment of the present invention is depicted. As shown in FIG. 3, a plurality of ultra-capacitors 310 are positioned and connected to fins 330, using one or more nuts 322. Fins 330 serve two purposes: i) they create an enclosure for ultra-capacitors 310 and; ii) they provide for electrical connectivity between the various ultra-capacitors 310. Additionally, as shown in FIG. 3, terminal 320 provides a connection point for charging and discharging one or more ultra-capacitors 310. Further, one or more fans 340 may be used to enhance airflow within the housing formed by fins 330, thereby enhancing the cooling of ultra-capacitors 310. By placing fins 330 in various configurations, depending on the specific application and power supply requirements, ultra-capacitors 310 may be connected in any combination of parallel and/or serial circuits.

Referring now to FIG. 4, a perspective cutaway view of an ultra-capacitor power supply 300 with isolation elements suitable for use in conjunction with an ultra-capacitor welder with an integrated thermal management system in accordance with a preferred embodiment of the present invention. As shown in FIG. 4, isolation elements 410 have been affixed to the exterior surface of fins 330 so as to provide additional structural support and electrically isolate the components associated with ultra-capacitor 310 from other components and modules. Terminals 320 provide a connection point for charging and discharging ultra-capacitor 310. Further, one or more fans 340 may be used to enhance airflow over at least one surface of isolation elements 410, thereby enhancing the cooling of ultra-capacitors 310.

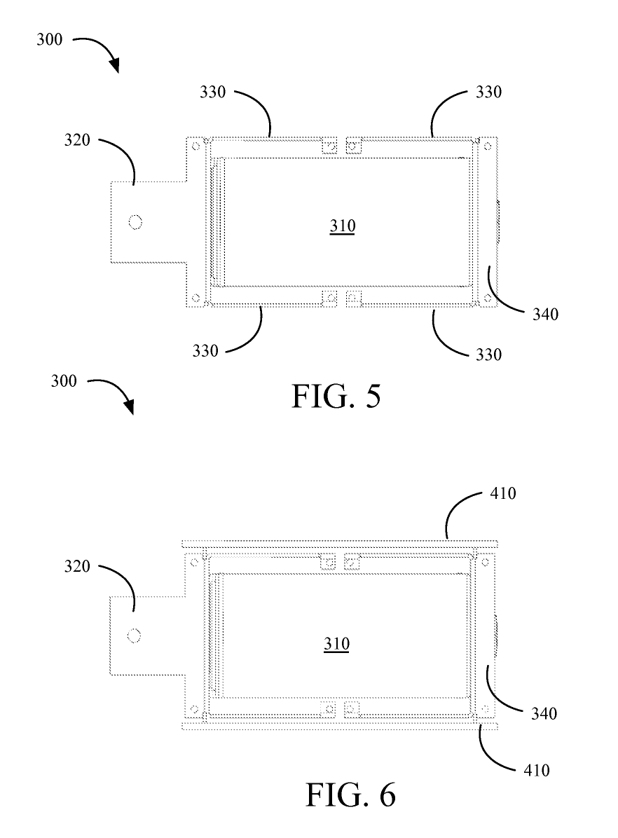

Referring now to FIG. 5, a side cutaway view of an ultra-capacitor with fins suitable for use in conjunction with an ultra-capacitor welder with an integrated thermal management system in accordance with a preferred embodiment of the present invention is depicted. Fins 330 serve two purposes: i) they create an enclosure for ultra-capacitors 310 and; ii) they provide for electrical connectivity between the various ultra-capacitors 310. Additionally, as shown in FIG. 5, terminal 320 provides a connection point for charging and discharging one or more ultra-capacitors 310. Terminals 320 provide a connection point for charging and discharging ultra-capacitor 310. Further, one or more fans 340 may be used to enhance airflow through the housing formed by fins 330, thereby enhancing the cooling of ultra-capacitor 310.

Referring now to FIG. 6, a side cutaway view of an ultra-capacitor with fins and isolation elements suitable for use in conjunction with an ultra-capacitor welder with an integrated thermal management system in accordance with a preferred embodiment of the present invention is depicted. As shown in FIG. 6, isolation elements 410 have been affixed to the surface of fins 330 so as to provide additional structural support and electrically isolated the components associated with ultra-capacitor 310 from other components and modules. Terminal 320 provides a connection point for charging and discharging ultra-capacitor 310. Further, one or more fans 340 may be used to enhance airflow over at least one surface of isolation elements 410, thereby enhancing the cooling of ultra-capacitors 310.

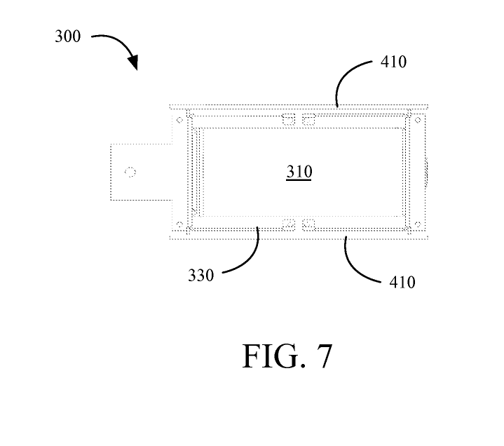

Referring now to FIG. 7, a side cutaway view of an ultra-capacitor with fins and isolation elements suitable for use in conjunction with an ultra-capacitor welder with an integrated thermal management system in accordance with an alternative preferred embodiment of the present invention is depicted. As shown in FIG. 7, isolation elements 410 may be positioned at some distance relative to fins 330 and ultra-capacitor 310 as necessary to control the airflow over ultra-capacitor 301, fins 330 and isolation elements 410 so as to achieve the desired results for a given application.

Referring now to FIG. 8, a side cutaway perspective view of an ultra-capacitor power supply with fans suitable for use in conjunction with an ultra-capacitor welder with an integrated thermal management system in accordance with a preferred embodiment of the present invention is depicted. As shown in FIG. 8, isolation elements 410 are positioned so as to direct airflow from fans 810 over the interior and exterior surface of fins 330 and of the surface of ultra-capacitors 310. Fans 810 are configured so that air is drawn into the power supply housing at one end and exhausted out of the power supply housing at the other end.

Referring now to FIG. 9, a side cutaway perspective view of an ultra-capacitor power supply with fans suitable for use in conjunction with an ultra-capacitor welder with an integrated thermal management system in accordance with an alternative preferred embodiment of the present invention is depicted. As shown in FIG. 9, isolation elements 410 are positioned so as to direct airflow from fans 910 over the interior surface of fins 330 only and of the surface of ultra-capacitors 310. Fans 910 are configured so that air is drawn into the power supply housing at one end and exhausted out of the power supply housing at the other end.

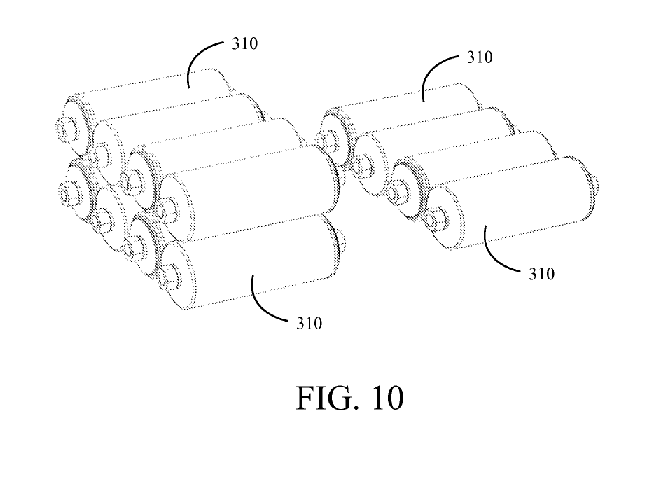

Referring now to FIG. 10, a perspective view of two different arrangements for ultra-capacitors suitable for use in an ultra-capacitor welder thermal management system in accordance with a preferred embodiment of the present invention is depicted. As shown in FIG. 10, ultra-capacitors 310 can be arranged and coupled in a variety of forms. The single stack version shown on the right is the most preferred embodiment, primarily for heat dissipation and flexibility in power and thermal management of the ultra-capacitor array.

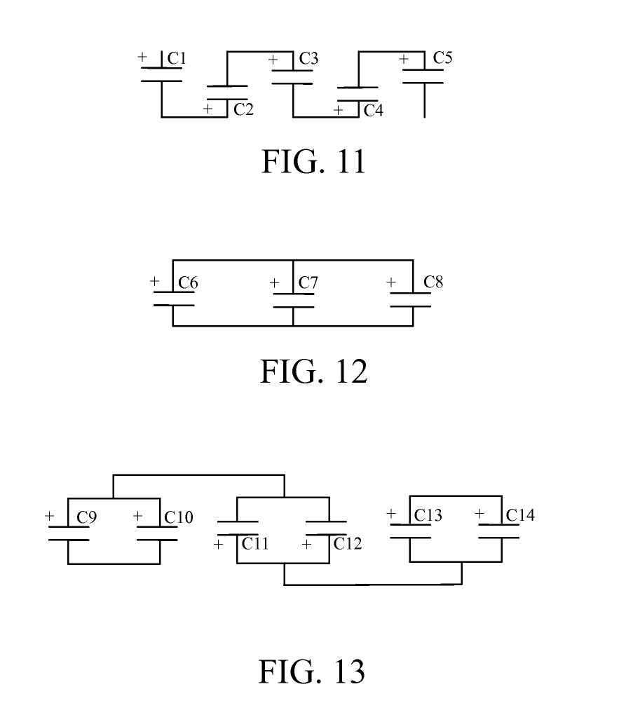

Referring now to FIG. 11, a circuit schematic of a plurality of ultra-capacitors connected in series to be used in conjunction with an ultra-capacitor power supply in accordance with a preferred embodiment of the present invention is depicted. As shown in FIG. 11, each of capacitors C1, C2, C3, C4, and C5 are connected in series. This is accomplished by affixing fin elements to the terminals of capacitors C1, C2, C3, C4, and C5 so as to form a series electrical connection between each of the capacitors (e.g., the positive terminal of each capacitor is electrically connected to the negative terminal of the next capacitor by the same electrically conductive fin element).

Referring now to FIG. 12 a circuit schematic of a plurality of ultra-capacitors connected in parallel to be used in conjunction with an ultra-capacitor power supply in accordance with a preferred embodiment of the present invention is depicted. As shown in FIG. 12, each of capacitors C6, C7, and C8 are connected in parallel. This is accomplished by affixing fin elements to the positive terminals for each of capacitors C6, C7, and C8 so as to form a parallel electrical connection between each of the capacitors (e.g., the positive terminal of each capacitor is electrically connected to the same electrically conductive fin element).

Referring now to FIG. 13 a circuit schematic of a plurality of ultra-capacitors connected both in series and in parallel to be used in conjunction with an ultra-capacitor power supply in accordance with a preferred embodiment of the present invention is depicted. As shown in FIG. 13, capacitors C9 and C10 are connected in parallel, capacitors C11 and C12 are connected in parallel, and capacitors C13 and C14 are connected in parallel. Then, each parallel capacitor combination is connected in series with the subsequent capacitor combination.

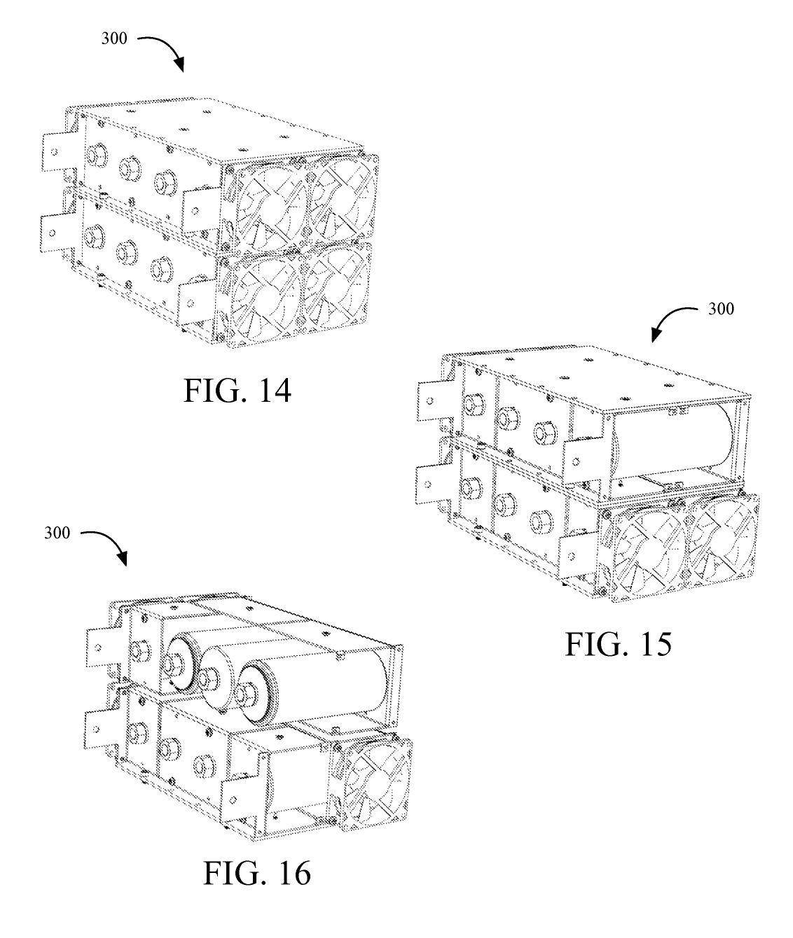

Referring now to FIG. 14, FIG. 15, and FIG. 16, partial cutaway perspective views of various configurations for ultra-capacitor power supplies 300 suitable for use in conjunction with an ultra-capacitor welder with an integrated thermal management system in accordance with a preferred embodiment of the present invention are depicted. These various views depict the modular nature of the power supply and illustrate how completed modules may be stacked and bolted together, ready for connection in parallel or series or use as multiple independent capacitor banks.

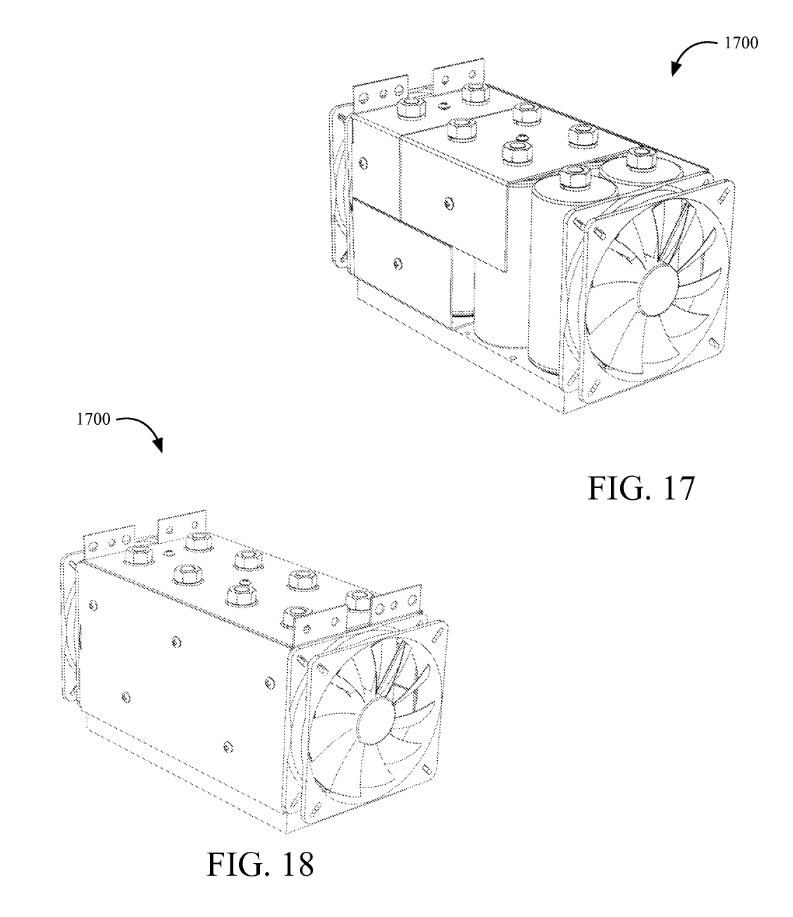

Referring now to FIG. 17, partial cutaway perspective views of a configuration an ultra-capacitor welder with an integrated thermal management system 1700 in accordance with a preferred embodiment of the present invention are depicted. This configuration illustrates the use of both parallel and series connections for the ultra-capacitors used in power supply and integrated thermal management system 1700.

Referring now to FIG. 18, a partial cutaway perspective view of an ultra-capacitor welder power supply and thermal management system 1700 in accordance with a preferred embodiment of the present invention is depicted. As shown in FIG. 18, isolation elements have been affixed to the exterior of power supply and thermal management system 1700.

As described herein, the various preferred embodiments of the present invention provide for significant advancement over the current options for capacitive discharge welding applications. Specifically, at least one preferred embodiment of the present invention provide for a linear DC welder that uses a standard 110V/220V power supply instead of the more costly and less available than a three phase power supply. In addition to welder power supplies, the various preferred embodiments of the present invention may be deployed wherever a power supply with the characteristics of the ultra-capacitor power supply described herein are useful.

Additionally, the use of super capacitors provides a welder with significantly longer weld times than offered by a typical HF welder. With consistent weld times in the range of 3 seconds, welding operations can be completed with less down time for various applications that require such weld times.

Further, the super capacitor welder of the present invention provides for a higher repetition rate, similar to the repetition rate offered by an HF welder while provide a much more convenient form factor since no power transformer is required as with an HF welder. Finally, the super capacitor welder of the present invention is capable of performing high precision welds in the same fashion as a typical linear DC welder.

Additionally, the inclusion of an ultra-capacitor power supply with an integrated management system provides for a more robust power supply. The thermal housing, comprising fins and optional isolation elements, also offers significant flexibility in the arrangement and configuration of the power supply components.

From the foregoing description, it should be appreciated that the various preferred embodiments of the present invention disclosed herein presents significant benefits that would be apparent to one skilled in the art. For example, those skilled in the art will recognize that the functions and operations of user interface device 212, CPU 214, control board 216, and emergency stop circuit 270 of FIG. 2 may be implemented in a number of different ways. A single personal computer, configured with the appropriate hardware and software, could be used to control power board 201 and welder 200.

Furthermore, while multiple embodiments have been presented in the foregoing description, it should be appreciated that a vast number of variations in the embodiments exist. Lastly, it should be appreciated that these embodiments are preferred exemplary embodiments only and are not intended to limit the scope, applicability, or configuration of the invention in any way. Rather, the foregoing detailed description provides those skilled in the art with a convenient road map for implementing a preferred exemplary embodiment of the invention, it being understood that various changes may be made in the function and arrangement of elements described in the exemplary preferred embodiment without departing from the spirit and scope of the invention as set forth in the appended claims. For example, those skilled in the art will recognize that the various preferred embodiments of the present invention have applications outside the realm of linear DC welders and may be useful for other equipment where the performance characteristics of the power supply and thermal management system described herein are applicable.

1. A power supply comprising:
at least one ultra-capacitor;
a plurality of conductive fins coupled to the at least one ultra-capacitor wherein the plurality of conductive fins form a housing for the at least one ultra-capacitor and wherein the conductive fins provide an electrical connection between the housing and the ultra-capacitor and an electrical circuit.

2. The power supply of claim 1 wherein the at least one ultra-capacitor comprises a plurality of ultra-capacitors and wherein the plurality of ultra-capacitors are connected in a series circuit.

3. The power supply of claim 1 wherein the at least one ultra-capacitor comprises a plurality of ultra-capacitors and wherein the plurality of ultra-capacitors are connected in a parallel circuit.

4. The power supply of claim 1 wherein the at least one ultra-capacitor comprises a plurality of ultra-capacitors and wherein at least two of the plurality of ultra-capacitors are connected in a parallel circuit and wherein at least two of the plurality of ultra-capacitors are connected in a series circuit.

5. The power supply of claim 1 further comprising a plurality of isolation elements affixed to the plurality of conductive fins.

6. The power supply of claim 1 further comprising at least one fan coupled to the power supply, the at least one fan creating an airflow within the housing formed by the plurality of conductive fins.

7. The power supply of claim 1 wherein the at least one ultra-capacitor comprises a plurality of ultra-capacitors and wherein at least two of the plurality of ultra-capacitors are connected in a parallel circuit and wherein at least two of the plurality of ultra-capacitors are connected in a series circuit and further comprising:
a plurality of isolation elements affixed to the plurality of conductive fins; and
at least one fan coupled to the power supply, the at least one fan creating an airflow within the housing formed by the plurality of conductive fins.

8. The power supply of claim 1 wherein the at least one ultra-capacitor comprises a plurality of ultra-capacitors and wherein the plurality of ultra-capacitors are arranged in two modular banks and wherein each of the modular banks comprises:
a plurality of ultra-capacitors;
a plurality of conductive fins coupled to the plurality of ultra-capacitors wherein the plurality of conductive fins form a housing for the plurality of ultra-capacitors and wherein the conductive fins provide an electrical connection between at least two of the plurality of ultra-capacitors;
a plurality of isolation elements affixed to the plurality of conductive fins; and
at least one fan coupled to the power supply, the at least one fan creating an airflow within the housing formed by the plurality of conductive fins.

9. The power supply of claim 1 further comprising:
a plurality of isolation elements affixed to the plurality of conductive fins; and
at least one fan electrically coupled to the power supply, wherein the at least one fan creates a first airflow within the housing formed by the plurality of conductive fins and wherein the at least one fan creates a second airflow that contacts the plurality of conductive fins on at least one of an interior surface of each of the plurality of conductive fins and an exterior surface of each of the plurality of conductive fins.

10. A method of providing power for a power supply comprising the steps of:
providing at least one ultra capacitor; and
coupling a plurality of conductive fins to the at least one ultra-capacitor wherein the plurality of conductive fins form a housing for the at least one ultra-capacitor and wherein the conductive fins provide an electrical connection between the housing and the at least one ultra-capacitor and an electrical circuit.

11. The method of claim 10 wherein the at least one ultra-capacitor comprises a plurality of ultra-capacitors and wherein the plurality of ultra-capacitors are connected in a series circuit.

12. The method of claim 10 wherein the at least one ultra-capacitor comprises a plurality of ultra-capacitors and wherein the plurality of ultra-capacitors are connected in a parallel circuit.

13. The method of claim 10 wherein the at least one ultra-capacitor comprises a plurality of ultra-capacitors and wherein a first portion of the plurality of ultra-capacitors are connected in a parallel circuit and wherein a second portion of the plurality of ultra-capacitors are connected in a series circuit.

14. The method of claim 10 wherein the housing formed by the conductive fins further comprises a plurality of isolation elements affixed to the plurality of conductive fins.

15. The method of claim 10 wherein the housing formed by the conductive fins further comprises at least one fan coupled to the power supply, the at least one fan creating an airflow within the housing formed by the plurality of conductive fins.

16. The method of claim 10 wherein the at least one ultra-capacitor comprises a plurality of ultra-capacitors and wherein a first portion of the plurality of ultra-capacitors are connected in a parallel circuit and wherein a second portion of the plurality of ultra-capacitors are connected in a series circuit and further comprising:
a plurality of isolation elements affixed to the plurality of conductive fins; and
at least one fan coupled to the power supply, the at least one fan creating an airflow within the housing formed by the plurality of conductive fins.

17. The method of claim 10 wherein the at least one ultra-capacitor comprises a plurality of ultra-capacitors and wherein the plurality of ultra-capacitors are arranged in two modular banks and wherein each of the modular banks comprises:
a plurality of ultra-capacitors;
a plurality of conductive fins coupled to the plurality of ultra-capacitors wherein the plurality of conductive fins form a housing for the plurality of ultra-capacitors and wherein the conductive fins provide an electrical connection between at least two of the plurality of ultra-capacitors;
a plurality of isolation elements affixed to the plurality of conductive fins; and
at least one fan coupled to the power supply, the at least one fan creating an airflow within the housing formed by the plurality of conductive fins.

18. The method of claim 1 wherein the housing formed by the conductive fins further comprises:
a plurality of isolation elements affixed to the plurality of conductive fins; and
at least one fan coupled to the power supply, wherein the at least one fan creates a first airflow within the housing formed by the plurality of conductive fins and wherein the at least one fan creates a second airflow that contacts the plurality of conductive fins on at least one of an interior surface of each of the plurality of conductive fins and an exterior surface of each of the plurality of conductive fins.

19. A power supply for a capacitive discharge welder comprising:
a bank of super capacitors coupled to the power supply, the power supply energizing the bank of super capacitors, the bank of super capacitors generating an electrical current;
an emergency stop circuit coupled to the bank of super capacitors;
a switch coupled to the emergency stop circuit;
a CPU coupled to the switch, the CPU sending a signal to the switch in response to an emergency signal, the switch redirecting the electrical current generated by the bank of super capacitors to a resistive load;
a user interface device coupled to the CPU, the user interface device displaying a graphical user interface;
a filter capacitor coupled to the bank of super capacitors, the filter capacitor creating a filtered output current waveform from the electrical current generated by the bank of super capacitors;
a weld switch, the weld switch repeatedly switching the electrical current generated by the at least one super capacitor on and off a weld path at a controlled rate;
a control board coupled to the CPU, the control board receiving data transferred from the user interface device;
a power supply control circuit coupled to the CPU, the power supply control circuit controlling the electrical current generated by the bank of super capacitors;
a plurality of conductive fins coupled to the bank of ultra-capacitors wherein the plurality of conductive fins form a housing for the bank of ultra-capacitors and wherein the conductive fins provide an electrical connection between at least two ultra-capacitors in the bank of ultra-capacitors.
